(19) United States
(12) Patent Application Publication
(10) Pub. No.: US 2011/0314968 A1
(43) Pub. Date: Dec. 29, 2011

(54) Pop-top (tab) can opener

(76) Inventor: Natalya E. Hill, Raleigh, NC (US)

(21) Appl. No.: 13/134,984

(22) Filed: Jun. 22, 2011

Related U.S. Application Data
(60) Provisional application No. 61/358,444, filed on Jun. 25, 2010.

(51) Int. Cl. B67B 7/00

(52) U.S. Cl. 81/3.07

(57) ABSTRACT

A pop-top can opener that includes a cavity into which the tab of a pop-top can is inserted and a lever end which allows the user to provide a leverage to the tab to open the can without the risk of damaging fingernails. A notch can be provided in the side of the device for removing the caps from bottles.

### TECHNICAL FIELD

The present invention relates to pop-top can opening tools and more particularly to a pop-top tab opener that includes a hollow, flat, plastic or metal strip with a semi-circular cut-out at one end and a hollow cavity in connection with the semi-circular cut-out that is sized to receive the pop-top tab of a tab of a can therein; the strip being sufficiently long such that the device can provide additional leverage as well as prevent the risk of damaging the fingernails of the person opening the can; a side edge of the device is provided with a notch for popping the bottle cap off of bottles.

### BACKGROUND OF INVENTION

Many individuals such as bartenders, waiters and the like are required to constantly pop open pop-top cans and/or remove the caps from bottles. It can be difficult for women, in particular, having long fingernails to open the pop-top cans without damaging their fingernails. It would be a benefit, therefore, to have pop-top can opener that could be used to allow the tab of a pop-top can to be pressed in without allowing damage to the fingernails of the user.

### SUMMARY OF INVENTION

It is thus an object of the invention to provide a pop-top can opener that includes a hollow, flat, plastic or metal strip with a semi-circular cut-out at one end and a hollow cavity in connection with the semi-circular cut-out that is sized to receive the pop-top tab of a tab of a can therein; the strip being sufficiently long such that the device can provide additional leverage as well as prevent the risk of damaging the fingernails of the person opening the can; a side edge of the device is provided with a notch for popping the bottle cap off of bottles.

Accordingly, a pop-top can opener is provided. The pop-top can opener includes a hollow, flat, plastic or metal strip with a semi-circular cut-out at one end and a hollow cavity in connection with the semi-circular cut-out that is sized to receive the pop-top tab of a tab of a can therein; the strip being sufficiently long such that the device can provide additional leverage as well as prevent the risk of damaging the fingernails of the person opening the can; a side edge of the device is provided with a notch for popping the bottle cap off of bottles.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 shows a perspective view of an exemplary embodiment of the tab opener of the present invention.

FIG. 2 shows a second perspective view of the tab opener of the present invention with a tab of a soda can inserted into the tab receiving slot.

FIG. 3 shows a tab opener of the present invention with a bottle opener provided along one side edge.

### EXEMPLARY EMBODIMENTS

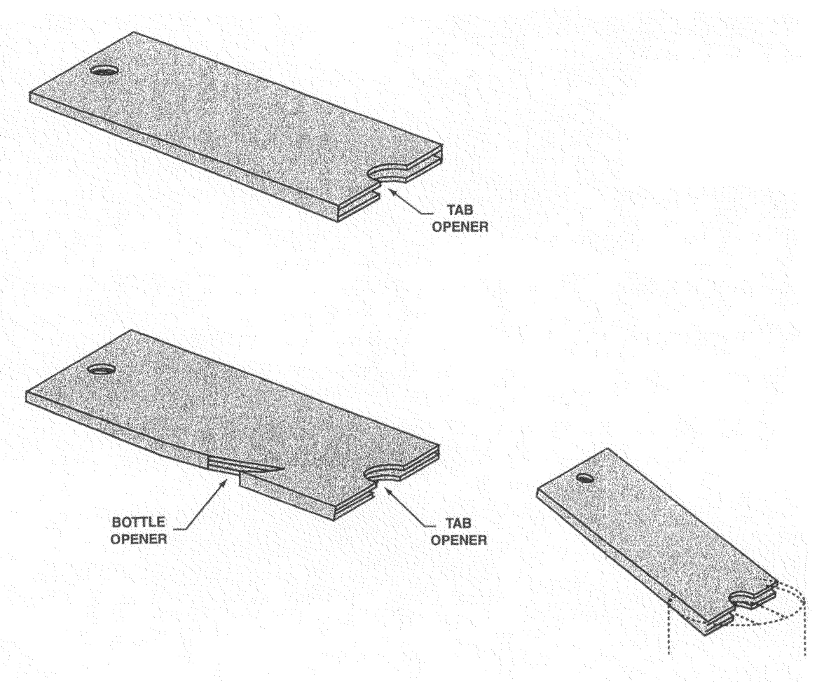

FIGS. 1 through 3 show various aspects of an exemplary embodiment of the pop-top can opener of the present invention generally designated 10. Pop-top can opener 10 includes a hollow flat plastic strip 12 having a semi-circular cut-out 14 that is in connection with a tab receiving cavity 16 that is sized and shaped to receive the pop-top tab of a can. A notch 26 is provided in the sides of some of the pop-top can openers 10 to allow the user to additionally use opener 10 for opening the caps from a bottle.

It can be seen from the preceding description that a pop-top can opener has been provided.

It is noted that the embodiment of the pop-top can opener described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. There are products with a similar name but none like the one I am seeking a patent for. The functionality and usage are very different One product had a large handle and most of the products were much larger in size. There were a few that were being used for a paint type can with a round top to open it not for a beverage can. Other products that were a bit similar had multiple functions and the large size was also a factor. When researching the different products I found that none of them are small, compact, shaped or work like “The Pop-Top (Tab) Can Opener”.
